(19) United States
(12) Patent Application Publication
(10) Pub. No.: US 2011/0153506 A1
(43) Pub. Date: Jun. 23, 2011

(54) PROJECT ANALYSIS TOOL

(75) Inventor: Daniel Edward Patterson, Austin, TX (US)

(73) Assignee: ACUMEN PM, LLC, Austin, TX (US)

(21) Appl. No.: 12/646,502

(22) Filed: Dec. 23, 2009

(51) Int. Cl. G06Q 10/00

(52) U.S. Cl. 705/301

(57) ABSTRACT

A project analysis tool receives a set of activities of a project, receives user input that specifies an activity attribute, groups the activities into groups according to different attribute values, and displays each group's activities within a line located by their start times. Alternatively, the tool receives user input that specifies a start entity and an end entity, determines paths of the activities of the project between the start entity and the end entity using received predecessor/successor relationships, and displays each path's activities within a line located by their start times. Alternatively, the tool creates time phases, populates them with activities based on start/end times, performs metric analysis on each time phase, and displays each time phase's analysis information. The tool also divides groups/paths into time phases across groups/paths, identifies segments that are the intersection of a time phase and a group/path, analyzes each segment and displays its analysis information.

### FIELD OF THE INVENTION

The present invention relates in general to the field of project management, and particularly to tools that enable a project manager to analyze projects.

### BACKGROUND OF THE INVENTION

Traditional project management scheduling techniques are based upon a globally accepted technique known as critical path analysis/method (CPM scheduling). Project analysts use CPM schedules to determine the timings of a project given durations of activities and sequence of work. To graphically display CPM schedules there are two well-accepted techniques: Gantt charts and network diagrams (job on node diagrams). Both techniques show not only the work (activities) but also the relationships between the activities. Most projects contain what are known within the project management industry as parallel paths. Parallel paths are the various path sequences of activities that need to be carried out in order to complete a project. One of the major drawbacks and challenges with the use of network diagrams and Gantt charts is the inability to easily trace sequenced sets of activities within paths. With so many inter-relationships and dependencies, following a sequence through a network for a complex project can be analogous to following a line of string in ball of string or an individual noodle in a bowl of spaghetti.

To further complicate the matter of gaining true insight into complex project schedules, projects typically have a hierarchy of activities. Summary activities (or what is known as work breakdown structure/WBS elements) can contain multiple child activities which themselves can also be summaries for their own children. Such hierarchies result in project schedules carrying additional depth of complexity.

Since the advent of Gantt charts, project schedulers and analysts alike have been trying to determine the quality of the planned work as well as the performance of the execution of the project using well-accepted metrics such as percent complete, remaining duration and actual cost. When trying to apply these metrics to the likes of Gantt charts, there lies a huge challenge in being able to easily determine which activities should be included in the analysis.

### BRIEF SUMMARY OF INVENTION

In one aspect the present invention provides a computer-implemented method. The method includes using a computer to perform receiving a set of activities of a project, wherein each of the activities specifies a start time and attributes. The method also includes using a computer to perform receiving, via an input device of the computer, user input that specifies an attribute from among the attributes of the set of activities. The method also includes using a computer to perform grouping the activities into groups according to different values of the attribute. The method also includes using a computer to perform, for each of the groups, displaying on an electronic display device of the computer the activities of the group within a single horizontal line, wherein each of the activities is displayed in a location within the single horizontal line based on its start time.

In another aspect, the present invention provides a computer-implemented method. The method includes using a computer to perform receiving a set of activities of a project, wherein each of the activities specifies a start time. The method also includes using a computer to perform receiving a set of relationships of the project, wherein each relationship specifies a preceding one of the activities and a succeeding one of the activities. The method also includes using a computer to perform receiving, via an input device of the computer, user input that specifies a start entity and an end entity. The method also includes using a computer to perform determining paths of the activities of the project between the start entity and the end entity using the set of relationships. The method also includes using a computer to perform, for each of the paths, displaying on an electronic display device of the computer the activities of the path within a single horizontal line, wherein each of the activities is displayed in a location within the single horizontal line based on its start time.

In yet another aspect, the present invention provides a computer-implemented method. The method includes using a computer to perform receiving a set of activities of a project, wherein each of the activities specifies a start time and end time. The method also includes using a computer to perform creating a plurality of time phases. The method also includes using a computer to perform populating the time phases with the activities based on the start time and the end time of each activity, wherein each of the activities may be placed into more than one of the time phases. The method also includes using a computer to perform, for each of the time phases, analyzing the time phase according to at least one metric to generate metric analysis information for each of the time phases. The method also includes using a computer to perform displaying on an electronic display device of the computer the metric analysis information for each of the time phases.

In yet another aspect, the present invention provides a computer-readable memory medium comprising program instructions. The program instructions are executable by a processor to implement receiving a set of activities of a project, wherein each of the activities specifies a start time and attributes. The program instructions are also executable by the processor to implement receiving, via an input device of the computer, user input that specifies an attribute from among the attributes of the set of activities. The program instructions are also executable by the processor to implement grouping the activities into groups according to different values of the attribute. The program instructions are also executable by the processor to implement, for each of the groups, displaying on an electronic display device of the computer the activities of the group within a single horizontal line, wherein each of the activities is displayed in a location within the single horizontal line based on its start time.

In yet another aspect, the present invention provides a computer-readable memory medium comprising program instructions. The program instructions are executable by a processor to implement receiving a set of activities of a project, wherein each of the activities specifies a start time. The program instructions are also executable by the processor to implement receiving a set of relationships of the project, wherein each relationship specifies a preceding one of the activities and a succeeding one of the activities. The program instructions are also executable by the processor to implement receiving, via an input device of the computer, user input that specifies a start entity and an end entity. The program instructions are also executable by the processor to implement determining paths of the activities of the project between the start entity and the end entity using the set of relationships. The program instructions are also executable by the processor to implement, for each of the paths, displaying on an electronic display device of the computer the activities of the path within a single horizontal line, wherein each of the activities is displayed in a location within the single horizontal line based on its start time.

In yet another aspect, the present invention provides a computer-readable memory medium comprising program instructions. The program instructions are executable by a processor to implement receiving a set of activities of a project, wherein each of the activities specifies a start time and end time. The program instructions are also executable by the processor to implement creating a plurality of time phases. The program instructions are also executable by the processor to implement populating the time phases with the activities based on the start time and the end time of each activity, wherein each of the activities may be placed into more than one of the time phases. The program instructions are also executable by the processor to implement, for each of the time phases, analyzing the time phase according to at least one metric to generate metric analysis information for each of the time phases. The program instructions are also executable by the processor to implement displaying on an electronic display device of the computer the metric analysis information for each of the time phases.

### BRIEF DESCRIPTION OF THE DRAWINGS

FIG. 1 is a block diagram illustrating a computer system for running a project analysis tool according to the present invention.

FIGS. 2 through 4 are a flowcharts illustrating operation of the project analysis tool on the computer system of FIG. 1 according to the present invention.

FIGS. 5 through 15 are screen shots illustrating various aspects of the operation of the project analysis tool of FIG. 1 according to the present invention.

### DETAILED DESCRIPTION OF THE INVENTION

Described herein are embodiments of a project analysis tool that provides a project analyst the ability to easily group project activities for analysis purposes. In particular, the tool enables the analyst to group project activities by a common user-selected attribute into multiple groups and to display the grouped activities altogether in a single timeline, or ribbon, in which each activity is located on its group's timeline according to its start date from which activity overlap and gap may be observed. The tool applies metrics to the activities of each group and displays each group's metric analysis information for focused visualization and analysis by the analyst. Additionally, the tool enables the analyst to group project activities into multiple paths based on the predecessor/successor relationships of the activities and to display the activities of each path altogether in a single timeline from which activity overlap and gap may be observed. The tool applies metrics to the activities of each path and displays each group's metric analysis information for focused visualization and analysis by the analyst. Still further, the tool enables the analyst to create time phases of the project and to divide up each group or path into the time phases across groups/paths to identify segments, which are intersections of the time phases and groups/paths. The tool applies metrics to the activities of each segment and displays each segment's metric analysis information for easy analysis by the analyst. Finally, the tool enables the analyst to create time phases and to group the project activities into the time phases (irrespective of group or path) based on each activity's start and end time. The tool applies metrics to the activities of each time phase and displays each time phase's metric analysis information for focused visualization and analysis by the analyst. As will be observed from the following description, an advantage of the tool is that it flattens the data that would normally be presented on many lines of a Gantt chart, for example, while still visually and analytically retaining the information of the various activities within the group, path, time phase, or segment. In contrast, conventional tool features, such as a project summary, although providing summary information, lose the information for the individual activities.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, optical storage, FLASH memory, or solid-state disk (SSD). The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, C#, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

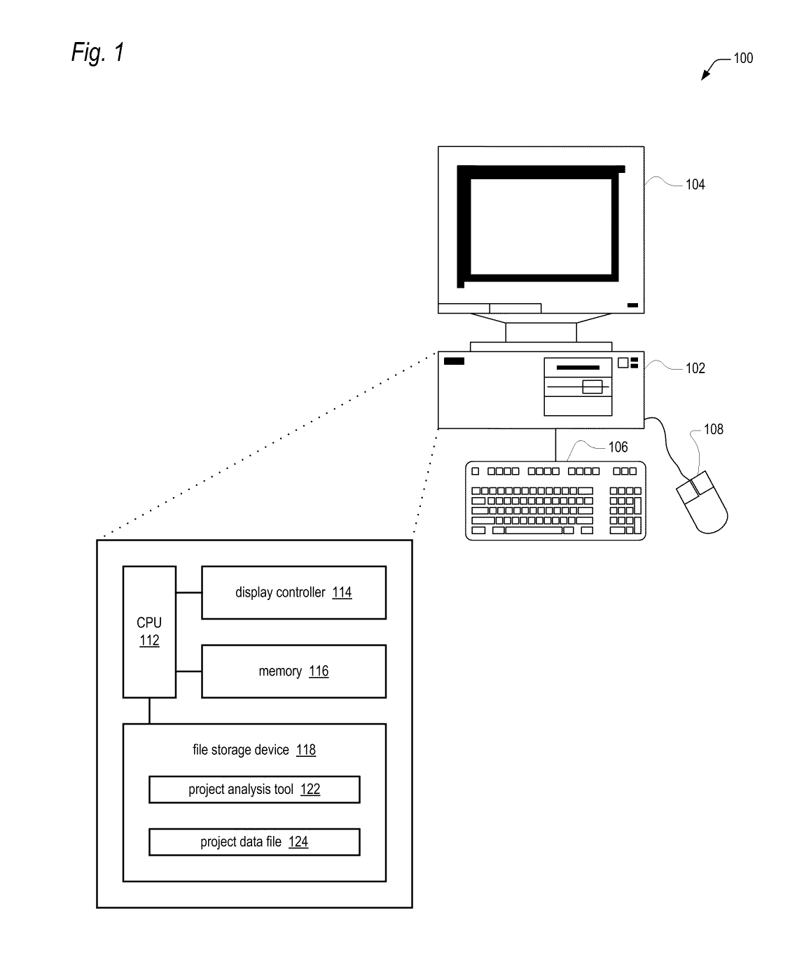

Referring now to FIG. 1, a block diagram illustrating a computer system 100 for running a project analysis tool 122 according to the present invention is shown. The computer system 100 includes an electronic display device 104; keyboard 106; and mouse 108 all coupled to a chassis 102 that encloses a central processing unit (CPU) 112; a display controller 114 for controlling the display device 104; memory 116, e.g., RAM and ROM memory; a file storage device 118, e.g., hard disk drive, CDROM drive, solid-state disk (SSD) memory; and other peripheral devices, such as a network interface controller. The computer system 100 is capable of executing an operating system, e.g., Microsoft® Windows®, MAC OS®, Linux, which is capable of loading a software program from the file storage 118 into memory 116 for execution by the CPU 112. In particular, the project analysis tool 122 according to the present invention is a software program that is installed on the storage device 118 and loaded into the memory 116 and executed by the CPU 112. Additionally, the tool 122 receives input from a project data file 124 stored on the storage device 118, as discussed in more detail below. A user of the computer system 100 provides input to the tool 122 via the keyboard 106, mouse 108, or other input devices, and the user may observe output on the display device 104 or other output devices, such as a printer. Although components of a well-known personal computer system are shown in FIG. 1, the tool 122 may be executed on any computer system adapted for execution thereof.

In one embodiment, the tool 122 comprises a product known as Acumen Fuse™ which is developed by Acumen PM, LLC of Austin, Tex. In one embodiment, the tool 122 is developed in a high-level programming language and compiled for execution on the Windows operating system. However, the tool 122 may be developed in any suitable programming language and compiled or translated to run on any operating system. The various electronic display device screen shots described herein are taken from an embodiment of the Acumen Fuse product.

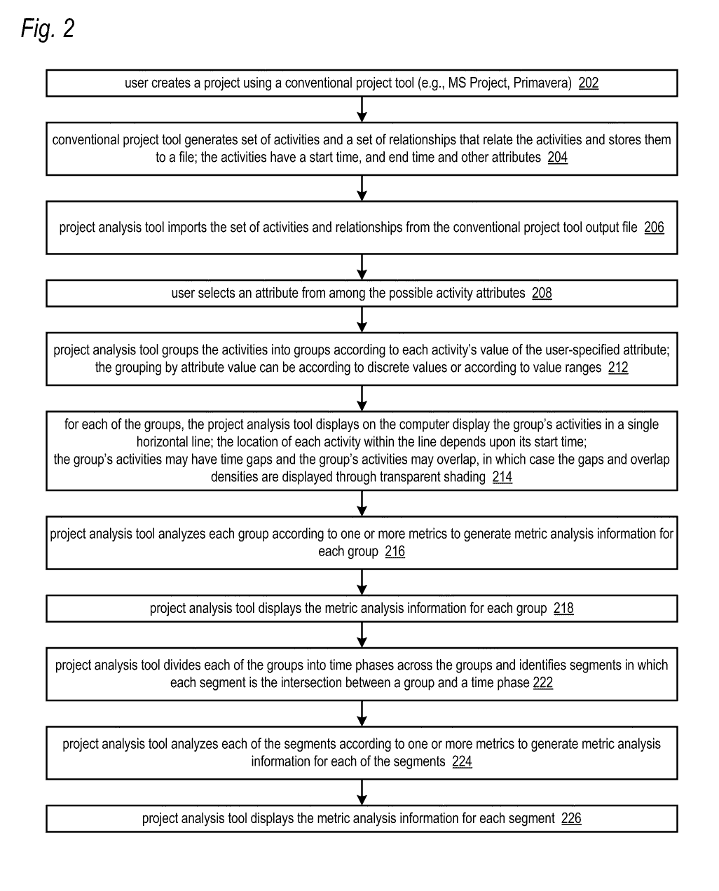

Referring now to FIG. 2, a flowchart illustrating operation of the project analysis tool 122 on the computer system 100 of FIG. 1 is shown. Flow begins at block 202.

At block 202, the user creates a project. In one embodiment, the user creates the project using a conventional project tool such as Microsoft Project®, Oracle Primavera® P6 or Pertmaster®, Microsoft Excel, or Deltek® Open Plan. That is, the user uses the conventional project tool to input activities of the project and their relationships to one another according to well-known project planning methods. The user enters values for various attributes of each activity such as an activity identifier, name and type; cost-related attribute values, such as actual cost, budget cost, remaining cost, and total cost; schedule-related attribute values, such as original duration, remaining duration, percent complete, start date, finish date, actual start date, actual finish date, budgeted start date, budgeted finish date, early start date, early finish date, total float, budgeted labor units, project start date, and project end date; critical activity indicator; activity relationship attribute values, such as number of predecessors, number of successors, number of lags, and number of leads; work breakdown structure code and work breakdown structure name. For each activity, the user also enters the predecessor activities and successor activities. For a finish-start relationship, the activity cannot start until its predecessor is finished; for start-start relationships, the activity cannot start until its predecessor is started; for start-finish relationships, the activity cannot finish until its predecessor is started; for finish-finish relationships, the activity cannot finish until its predecessor is finished. For a finish-start relationship, the successor of an activity cannot start until the activity is finished; for start-start relationships, the successor of an activity cannot start until the activity is started; for start-finish relationships, the successor of an activity cannot finish until the activity is started; for finish-finish relationships, the successor of an activity cannot finish until the activity is finished. Flow proceeds to block 204.

At block 204, the conventional project tool uses the information entered by the user to generate a set of activities of the project and relationships that relate the activities. In one embodiment, the activities and the relationships are objects in the well-known sense of object-oriented programming classes, such as C++ classes. Each of the activities has at least a start time, an end time, and other attributes, such as those described above with respect to block 202. The relationships specify predecessors and successors for the activities. The conventional project tool saves the activities and relationships to a file, namely the project data file 124 of FIG. 1. Flow proceeds to block 206.

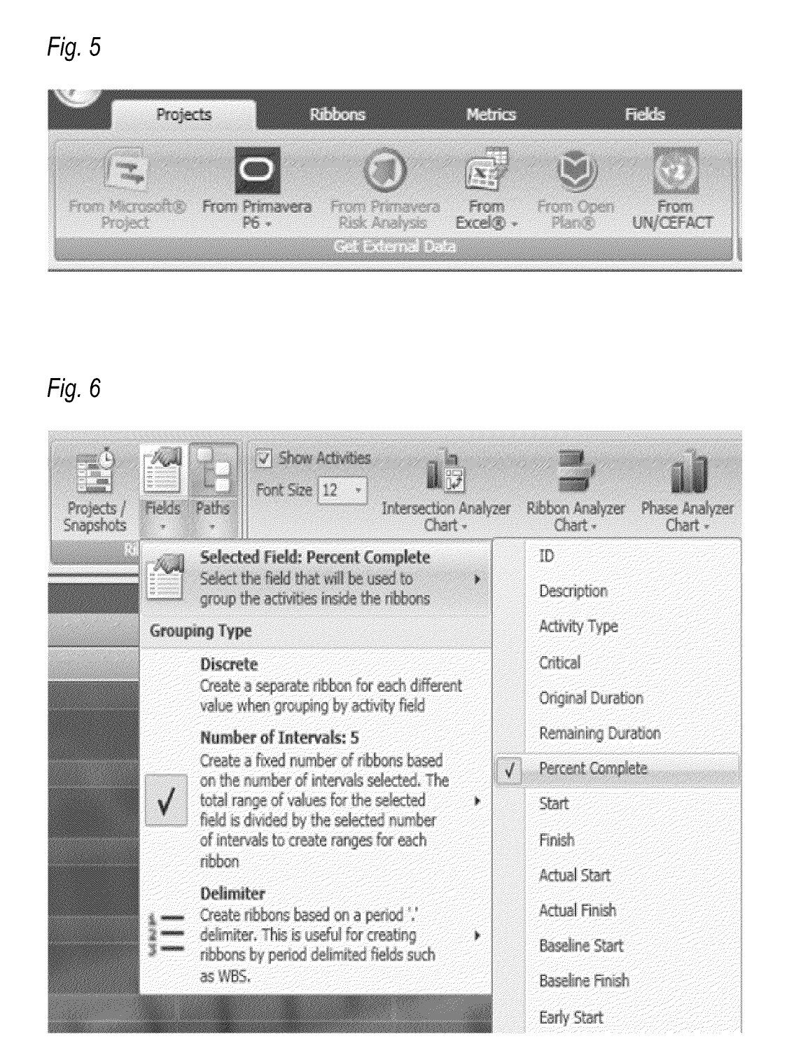

At block 206, the project analysis tool 122 imports the set of activities and relationships from the project data file 124 generated at block 204. In one embodiment, the tool 122 is capable of importing Microsoft Project® files, Primavera® P6 XER files, Oracle Primavera Risk Analysis/Pertmaster Plan files, Microsoft Excel files, Deltek® Open Plan files, and United Nations Centre for Trade Facilitation and Electronic Business (UN/CEFACT) files, as shown in FIG. 5. Furthermore, the tool 122 is capable of importing data from multiple projects for displaying and analyzing. Still further, the tool 122 enables the user to specify filters for filtering the data imported from the input file, such as importing only normal type activities as opposed to milestone or summary type activities. In one embodiment, the tool 122 receives input from a database rather than a file. Flow proceeds to block 208.

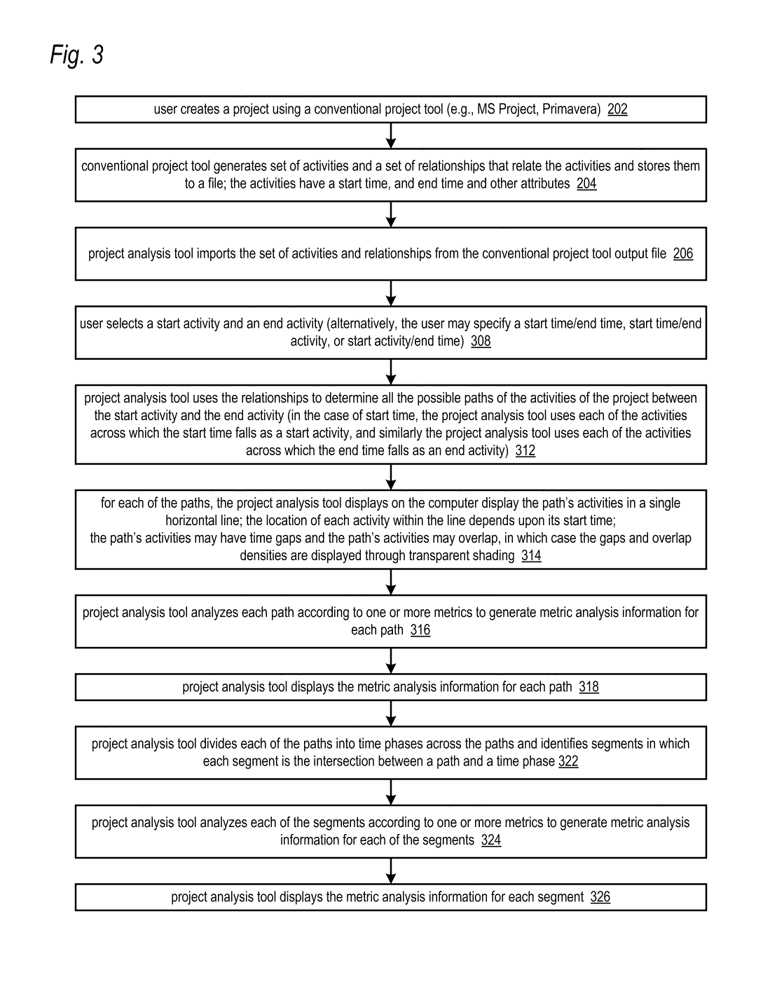

At block 208, the user selects an attribute from among the possible activity attributes included in the activities imported at block 206. The tool 122 displays the possible attributes for the user to select, as shown in FIG. 6. In FIG. 6, an attribute is referred to as a “Field.” The tool 122 uses the user-selected attribute to group activities into groups, as discussed below with respect to block 212. In the Acumen Fuse embodiment, the groups of activities are referred to as “Ribbons.” In addition to grouping ribbons by attribute, or field, the tool 122 also enables the user to group by project or snapshot (see Projects/Snapshots button of FIG. 6), in the case that multiple projects or project snapshots were imported at block 206. In this case, each group, or ribbon, includes the activities of a different project or snapshot. Additionally, rather than grouping Ribbons by attribute/field or project/snapshot, the user may also choose to group by path (see Paths button of FIG. 6), which is described in detail below with respect to the flowchart of FIG. 3. Flow proceeds to block 212.

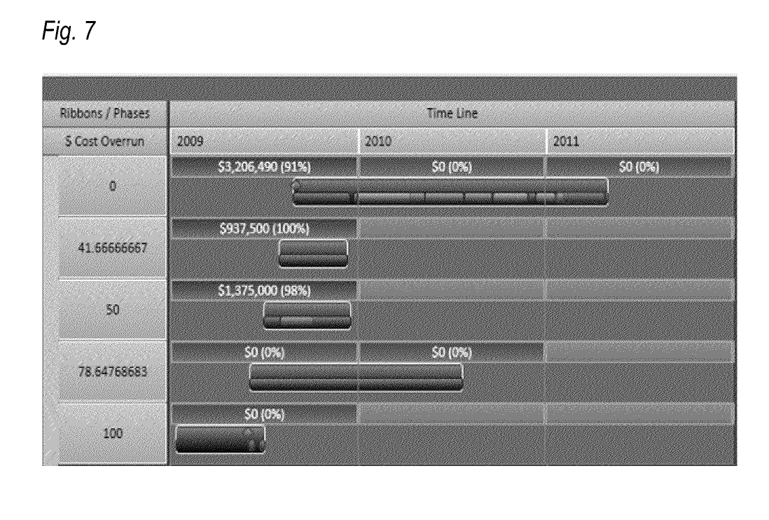

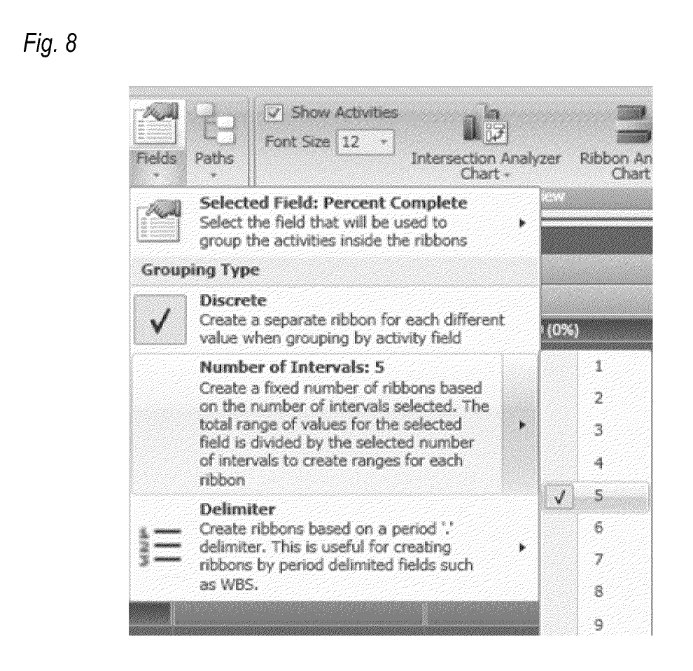

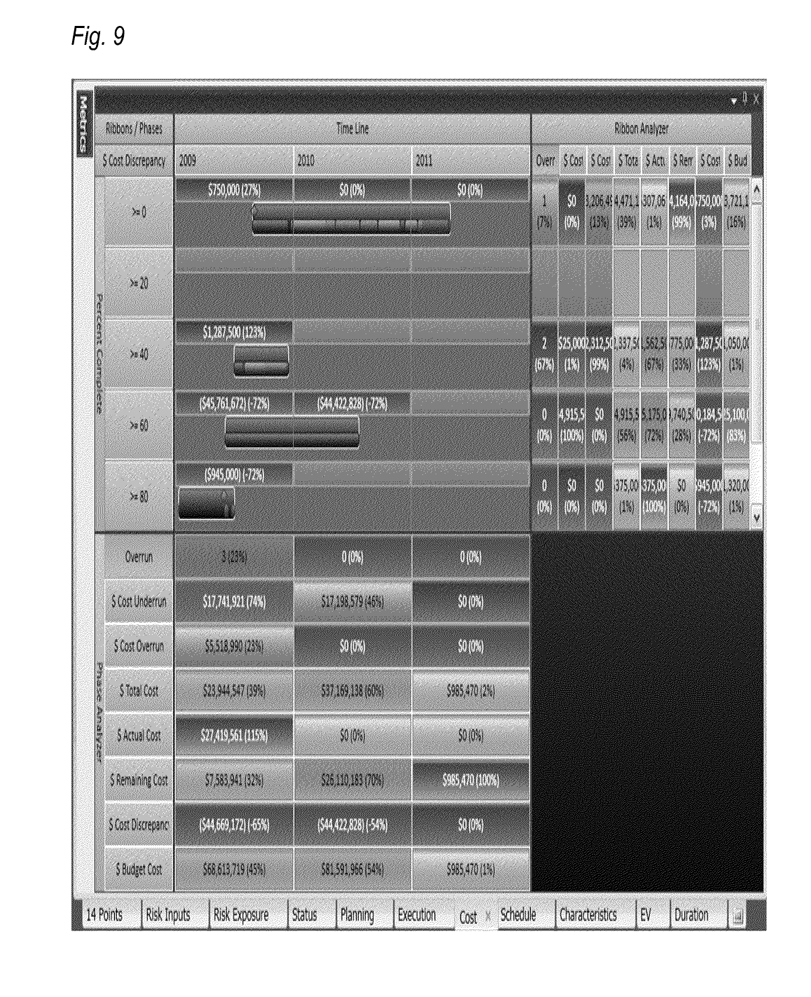

At block 212, the tool 122 groups the activities according to each activity's value of the attribute selected by the user at block 208. As shown in FIG. 6, when grouping by attribute, the user may select one of different grouping types, namely by discrete attribute value or by attribute value ranges (referred to as “Intervals” in FIG. 6). If the user chooses to group by discrete attribute values, the tool 122 creates a separate group, or ribbon, for each different value of the user-selected attribute. The tool 122 places each activity into its appropriate group based on its current value of the user-selected attribute. For example, if the user chooses to group by the percent complete attribute, and there are currently only five different values for the percent complete attribute among all the activities of the project, then the tool 122 creates five different ribbons, or groups, such that each of the groups has a different one of the five different percent complete values, as shown in FIG. 7 (0, 41.66666667, 50, 78.64768683, and 100). Alternatively, if the user chooses to group by value ranges (referred to as “Intervals” in FIG. 8), the tool 122 creates N groups, or ribbons, each having a different range of values for the user-selected attribute, where N is the number of ranges specified by the user. The tool 122 places each activity into its appropriate group based on which of the ranges the current value of the user-selected attribute falls into. For example, if the user chooses to group by the percent complete attribute and specifies five ranges, or Intervals, then the tool 122 creates five different ribbons, or groups, such that each of the groups has a different range of percent complete values, as shown in FIG. 9 (>=0, >=20, >=40, >=60, >=80). In one embodiment, the tool 122 supplies a default number of ranges. Advantageously, as described below, the groups may be the subject of metric analysis and may be displayed in a visually succinct manner for inspection by the user. Flow proceeds to block 214.

At block 214, for each of the groups created at block 212, the tool 122 displays on the electronic display device 104 the activities of the group, or ribbon, in a single horizontal line, as shown in FIG. 9. The length of the horizontal line (of potentially overlapping or gapping activities of the group) visually depicting the group is proportional to the time duration of the group, i.e., the length of the group's line is proportional to the time period that begins with the start date of earliest starting activity of the group and ends with the end date of the latest ending activity of the group. More specifically, the tool 122 places each activity of the group along the single line at a location on the line that is indicative of the start time of the activity. Each activity within the line is visually depicted as a rectangle whose length is proportional to the time duration of the activity, as shown in FIG. 9. The tool 122 displays gaps and overlaps in time between activities of a group through variable transparent shading density. In the example of FIG. 9, the greater number of activities that overlap within a time period the darker the rectangular area, and time gaps are shown as black rectangular areas within the horizontal line. In FIG. 9 the shading is according to grayscale; however, in at least one embodiment of the Acumen Fuse product the shading is in color. Red rectangular areas indicate critical activities, whereas blue rectangular areas indicate non-critical activities. Additionally, darker colored rectangular areas indicate more dense overlap of activities. For example, if a single activity falls within a time period, then the rectangular area representing the time period is displayed as a relatively light shade; if two activities fall within a time period (i.e., for the time period at least a portion of two activities overlap), then the rectangular area representing the time period is displayed as a darker shade; if three activities fall within a time period, then the rectangular area representing the time period is displayed as an even darker shade; and so forth. The displaying of all the activities of the entire group in a single horizontal line is advantageous because, unlike a Gantt chart, it gives the project analyst the ability to visualize the time relationships between various activities within a group in a single line; indeed, for large projects with many activities, it is quite possible that, if one activity is displayed per line as in a Gantt chart, all the activities of a group would not be visible on even a single screen of the electronic display device 104, much less on a single line. In one embodiment of the Acumen Fuse product, as shown in FIG. 9, the horizontal rectangle that visually depicts each group, or ribbon, is divided into two adjacent horizontal portions. The bottom portion displays normal type activities of the group, whereas the upper portion displays milestone and summary type activities of the group. Flow proceeds to block 216.

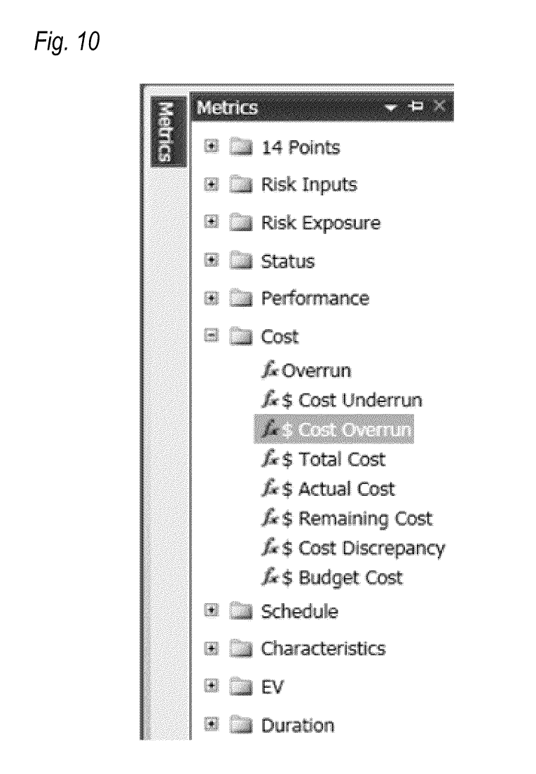

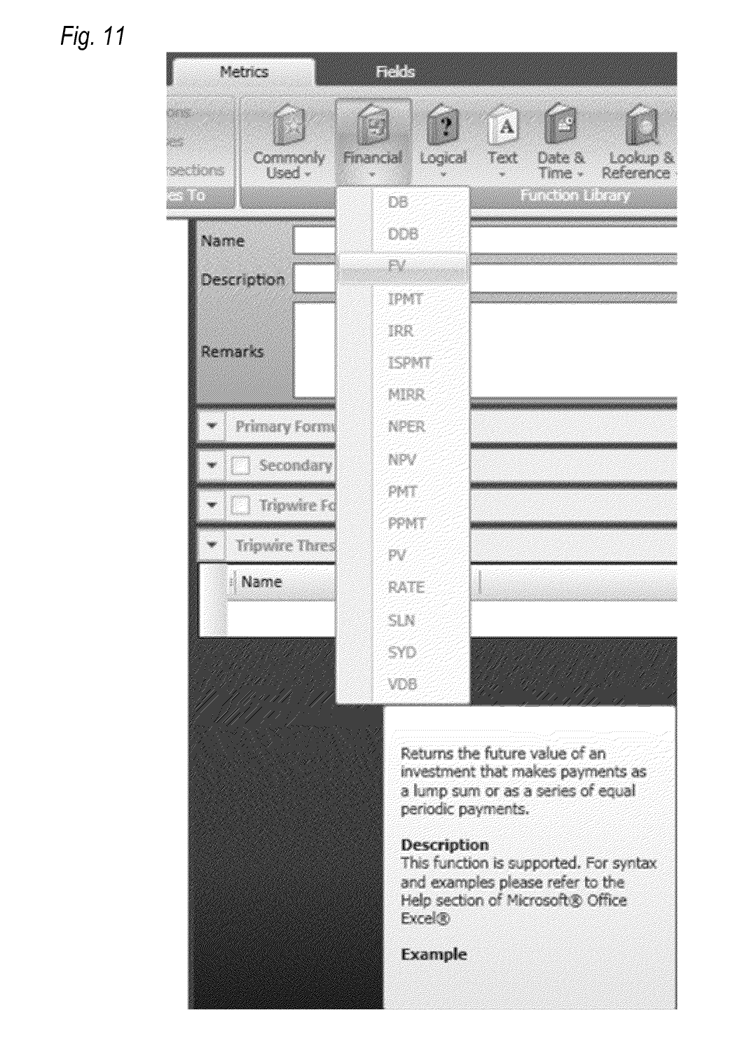

At block 216, the tool 122 analyzes each group according to one or more metrics to generate metric analysis information for each group. That is, for each group, tool 122 applies metrics to the values of the attributes of the activities in the group to generate information that may be used by a project analyst to analyze the project. The metrics comprise functions, or formulas. A metric function receives as input the relevant attribute values for all the activities of a group and generates the metric analysis information as output. The metrics are well-known in the art of project management. The Acumen Fuse embodiment provides built-in metric libraries, such as 14 Points, Risk Inputs, Risk Exposure, Status, Performance, Cost, Schedule, Characteristics, EV (Earned Value), and Duration, as shown in FIG. 10. Each of the metric libraries includes the individual metrics. For example, the individual metrics for the Cost metric library is shown in FIG. 10 (i.e., Overrun, Cost Underrun, Cost Overrun, Total Cost, Actual Cost, Remaining Cost, Cost Discrepancy, Budget Cost). The individual metrics for the other libraries include: 14 Points (Logic, Leads, Lags, FS Relations, Hard Constraint, High Float, Negative Float, High Duration, Invalid Dates, Resources, Missed Activities, CPLI, BEI); Risk Inputs (Aggressive, Conservative, Questionable Ranges, Broad Risk Range, Scope Uncertainty, No Risk, Average Risk Range, Total Risk Range, No Downside, No Upside, Average Days Upside, Average Days Downside); Risk Exposure (High Criticality, Hidden Paths, Risk Hot Spots, Schedule Risk Drivers, High Contingency, High Cost Drivers, Average Risk Exposure, Average Duration Sensitivity, Average Criticality, Average Cost Risk); Status (Underway, Planned Activities, Completed Activities, Days Remaining, Work Done, Completed Milestones, Planned Milestones); Performance (Planned Ahead, Planned Delayed, Planned On Schedule, Schedule to Start, Schedule to Finish, In-Progress Started Ahead, In-Progress Started Delayed, In-Progress Started On Schedule, Complete Finished Ahead, Complete Finished Delayed, Complete Finished On-Schedule, Accelerated, Average Days Early, Days Early, Average Days Started Late, Days Late, Average Discrepancy, Discrepancy, Actually Started, Actually Finished); Schedule (Missing Successors, Missing Predecessors, Wrong Status, Summary Links, Summarized Cost, Squashed Link, SS Relations, SF Relations, FF Relations); Characteristics (Milestones, Normal, Summaries, Hammocks, Activities, Milestone Ratio, Detail Level, Logic Density, Logic Hotspot, Diverge Hotspot, Float); EV (CV, SV, SPI, CPI); and Duration (Original Duration, Remaining Duration, Average Original Duration, Average Remaining Duration, Ribbon Length). The tool 122 provides the user the ability to select which metrics to apply to the relevant attribute values when analyzing the groups. For example, the tool 122 applies the Overrun metric (shown in FIG. 9) to each group as follows: the tool 122 compares the total cost of each activity in the group with its budget cost; the tool 122 then generates a sum which is the number of activities of the group whose total cost is greater than its budget cost; the sum is the metric analysis information for the Overrun metric of the group. Additionally, the tool 122 provides the user the ability to create custom metrics from a library of functions, as shown in FIG. 11. The function library includes financial functions, such as declining balance, future value, internal rate of return, and so forth; logical functions, such as Boolean functions; text functions; data and time functions; mathematical and statistical functions, such as average, binomial distribution probability, confidence interval, correlation coefficient, covariance, sum of squares deviation, exponential distribution, frequency, gamma distribution, maximum, minimum, median, mode, normal distribution, percentile, rank, standard deviation, trigonometric functions and so forth. Still further, the tool 122 allows the user to set tripwire thresholds and to specify different colors and/or shades to visually indicate that a metric analysis value has exceeded a tripwire threshold. Flow proceeds to block 218.

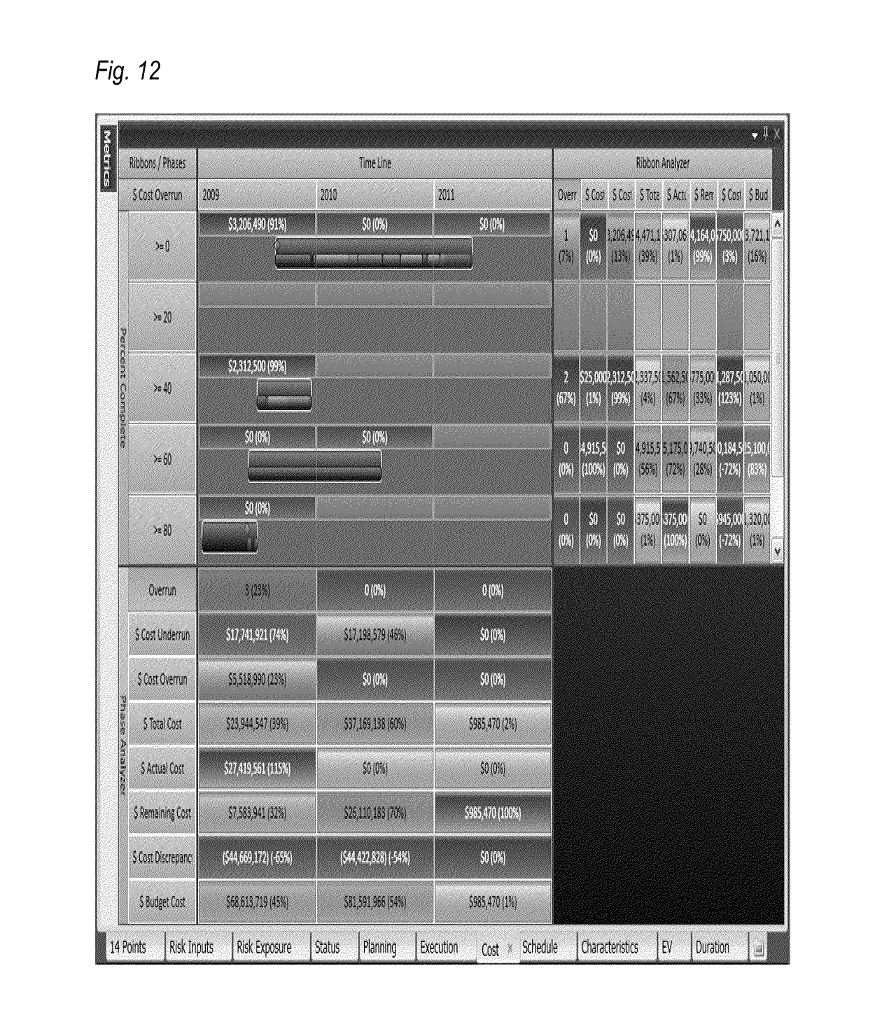

At block 218, the tool 122 displays the metric analysis information for each group that was generated at block 216. This is shown in FIG. 9 in the generic column titled “Ribbon Analyzer.” In the example of FIG. 9, the eight metrics from the Cost metric library have been applied to each of the groups, or ribbons, and the metric analysis information for each of the eight metrics is displayed in eight columns to the right of the respective groups, or ribbons. That is, each cell (intersection of a group row and Ribbon Analyzer metric column) displays metric analysis information for the metric (column) and group (row) intersection. The metric analysis information may be dollar amounts, times, and/or percentages, and so forth. For example, in FIG. 12, the Cost Overrun metric analysis information is displayed as both a dollar amount and as a percentage. Additionally, the tool 122 enables the user to specify different colors to be displayed in a cell by the tool 122 based on the relationship of the metric analysis result for the cell to various user-settable thresholds. For example, the user may specify that a cell be displayed in green if a group's cost overrun metric analysis result represents less than 25% of the total cost, yellow if the cost overrun is between 25% and 75% of the total cost, and red if the cost overrun is greater than 75%. The display of the metric analysis information for project activities grouped according to attribute advantageously provides a very efficient and useful way for the project analyst to analyze the project, which is not provided by conventional project analysis tools. Flow proceeds to block 222.

At block 222, the tool 122 divides up each of the groups into time phases, or time periods, across the groups and identifies segments. A time phase, or time period, is defined by the time it begins and the time it ends. The begin time and end time are specified as dates. The tool 122 creates the time phases based either on time phase information received from the user or on default time phase values. In the example shown in FIG. 12, the tool 122 created three time phases which are the years 2009, 2010, and 2011. Each segment is the intersection between a group and a time phase. The tool 122 provides the user the ability to specify the time phases and, therefore, the duration of the segments. A segment includes all the activities of the time phase-intersected group for which any of the duration of an activity falls within the intersecting time phase. Therefore, an activity may fall into multiple segments. Thus, in the example of FIG. 12, if an activity in the first group has a start time of Mar. 3, 2009 and an end time of Jun. 15, 2010, for example, then the tool 122 includes the activity both in the segment that is the intersection of the first group and the time phase year 2009 and in the segment that is the intersection of the first group and the time phase year 2010. The inclusion or exclusion of an activity in a segment is particularly relevant to the metric analysis of a segment, which is described below with respect to block 224. The tool 122 provides the user the ability to specify unequal time phases. Furthermore, the tool 122 provides the user the ability to subdivide an existing time phase. In one embodiment, the begin date and end date may have a granularity finer than a day, e.g., in terms of hours or minutes. Flow proceeds to block 224.

At block 224, the tool 122 analyzes each of the segments according to one or more metrics to generate metric analysis information for each of the segments identified at block 222. That is, the tool 122 applies metrics to the values of the attributes of the activities in the segment to generate information that may be used by a project analyst to analyze the project. The step performed at block 224 is similar to the step performed at block 216, except the set of activities analyzed at block 224 is the set of activities included in the relevant segment, rather than the set of activities included in the relevant group as at block 216. However, because an activity may fall into multiple segments (unlike the case of a group at block 216 in which an activity may only fall into one group), when the tool 122 applies a metric to a segment, if an activity falls within multiple segments, the manner in which the tool 122 applies the attribute value for that activity varies depending upon the type of attribute. For some attribute types (e.g., certain costs, time durations, and percentages), the tool 122 pro-rates the attribute value among the different segments according to the percentage of the activity's duration that lies within each of the different segments. For example, if an activity has a total cost of $100,000 and 25% of its duration falls within the first segment of two segments and 75% of its duration falls with the second segment, then the tool 122 applies $25,000 to the first segment and $75,000 to the second segment for metric analysis purposes. For other attribute types (e.g., attributes that have a binary value and text fields), the tool 122 fully includes the attribute value in each of the different segments. For still other attribute types (e.g., start time and end time), the tool 122 includes the attribute value only in the relevant segment. Flow proceeds to block 226.

At block 226, the tool 122 displays the metric analysis information for each segment that was generated at block 224. The tool 122 displays the metric analysis information for a segment in visual association with the segment. In one embodiment, the tool 122 displays the metric analysis information for each segment just above the horizontal line (described above with respect to block 214) in which the activities of the group, or ribbon, are displayed. More specifically, the tool 122 displays the metric analysis information for each segment above the segment's time phase-intersected portion of the horizontal line. Other embodiments are contemplated in which the tool 122 displays the metric analysis information for each segment below or within the segment's time phase-intersected portion of the horizontal line. In the example of FIG. 12, fifteen segments are displayed (five groups that intersect three time phases), including the corresponding metric analysis information for each of the segments. In one embodiment, the tool 122 enables the user to select the metric analysis information for one metric to be displayed for each segment at a time. In the embodiment of FIG. 12, the user has selected the metric analysis information for the Cost Overrun metric to be displayed for each segment. In the example of FIG. 12, eight of the fifteen segments are unpopulated with activities; therefore, the tool 122 does not display anything in the metric analysis information portion of the segment; rather, the tool 122 displays the metric analysis information for the Cost Overrun metric only for the seven populated segments. Additionally, the tool 122 enables the user to specify different colors to be displayed with respect to the segment metric analysis information similar to the manner described above with respect to block 218. The display of the metric analysis information for project activities grouped according to attribute and then segmented by dividing across groups by time phases advantageously provides a very efficient and useful way for the project analyst to analyze the project, which is not provided by conventional project analysis tools. Flow ends at block 226.

Referring now to FIG. 3, a flowchart illustrating operation of the project analysis tool 122 on the computer system 100 of FIG. 1 is shown. Flow begins at block 202. Blocks 202, 204, and 206 of FIG. 3 are similar to like-numbered blocks of FIG. 2. Flow proceeds from block 206 to block 308.

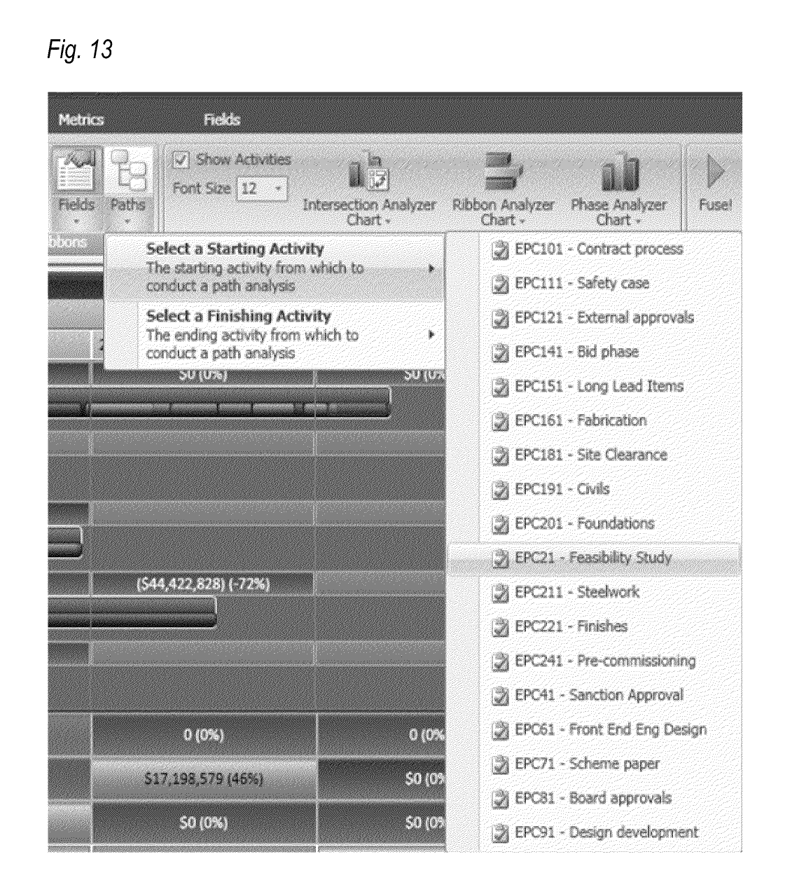

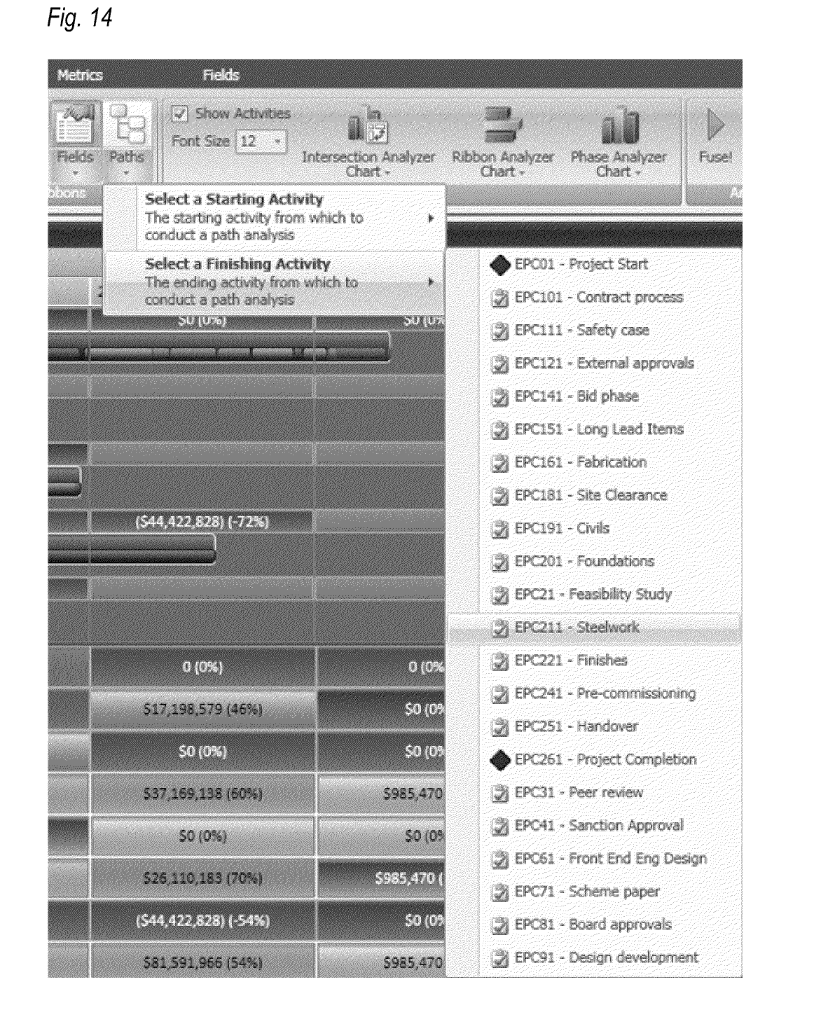

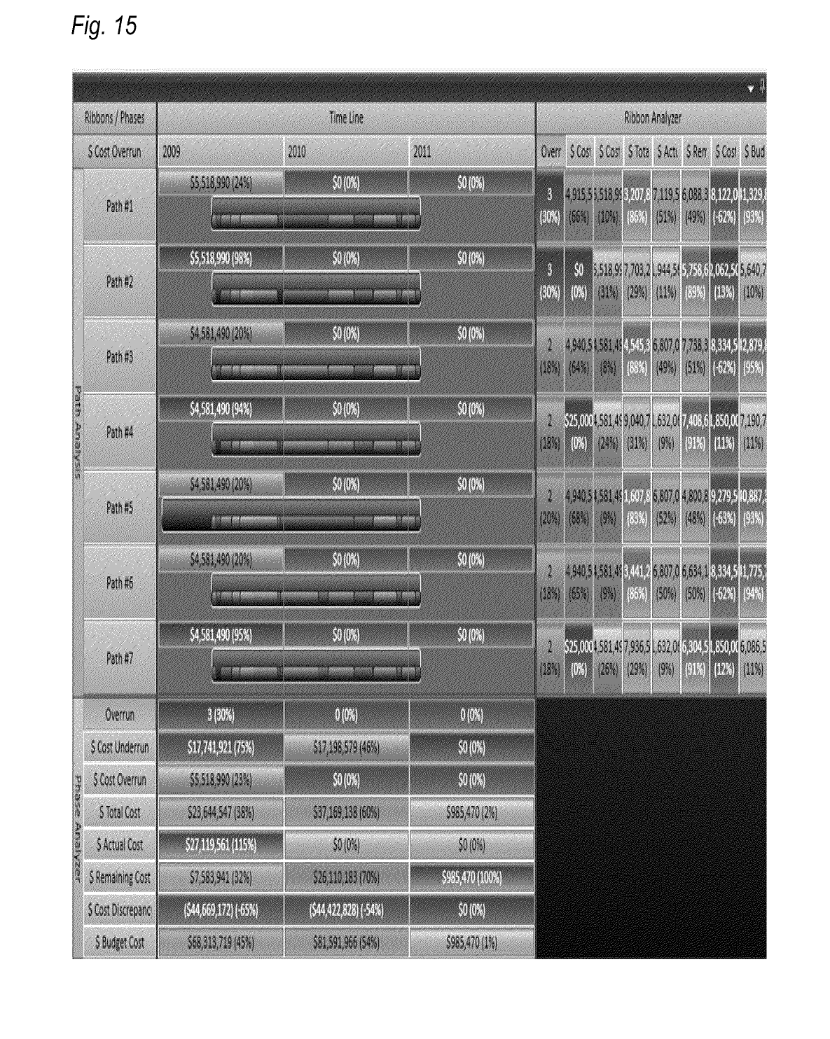

At block 308, the user selects a start activity and an end activity from among the set of activities of the project. As shown in FIGS. 13 and 14, the tool 122 displays the activities of the project for the user to select. The start activity and end activity will be used by tool 122 to determine paths, as described below with respect to block 312. Alternatively, instead of selecting a start activity and an end activity from among the set of activities of the project, the user may select a start time and an end time, a start activity and an end time, or a start time and an end activity. Flow proceeds to block 312.

At block 312, the tool 122 uses the relationships (imported at block 206) between the project activities to determine all the possible paths of the activities of the project between the start activity and end activity selected by the user at block 308. That is, the tool 122 designates the start activity as the first activity of potentially multiple paths to the end activity. Next, the tool 122 examines the relationships to determine the successors of the start activity and determines that a new path potentially exists through each of the successors. That is, if there are three successors of the start activity, for example, then the tool 122 determines three potential paths, namely a first potential path that includes the start activity and the first successor as its end node, a second potential path that includes the start activity and the second successor as its end node, and a third potential path that includes the start activity and the third successor as its end node. The tool 122 then recursively repeats the process beginning with the end node of each potential path until it reaches the end of each potential path. If the end of a potential path has as its end node the user-selected end activity, then the tool 122 includes the path in the set of paths for display and analysis at blocks 314 through 326 below. Thus, in this manner the tool 122 groups the activities of a project (or at least a subset thereof, depending upon the selected start activity and end activity) together into paths of activities. The grouping of activities by path, as described with respect to FIG. 3 is in contrast to grouping the activities of a project based on attribute, as described with respect to FIG. 2. However, once the activities are grouped, the displaying the paths, analyzing the paths, and displaying the metric analysis information of the paths, as described below, are largely similar to the same steps performed for the attribute-based groups as described above with respect to FIG. 2. If the user specifies a start time (rather than a start activity), then the start activity is the activity or activities of the project across which the user-selected start time falls. Thus, the tool 122 performs the process described above to determine the paths starting with potentially multiple start activities, i.e., the activities across which the start time falls. Similarly, if the user specifies an end time (rather than an end activity), then the end activity is the activity or activities of the project across which the user-selected end time falls. Flow proceeds to block 314.

At block 314, for each of the paths created at block 312, the tool 122 displays on the electronic display device 104 the activities of the path in a single horizontal line, as shown in FIG. 15. The visual manner in which the activities of the paths are displayed at block 314 is similar to the visual manner in which the activities of the groups, or ribbons, are displayed at block 214 as described above. The displaying of all the activities of an entire path in a single horizontal line is advantageous because, unlike a Gantt chart, it gives the project analyst the ability to visualize the time relationships between various activities within a path in a single line; indeed, for large projects with many activities, it is quite possible that, if one activity is displayed per line as in a Gantt chart, all the activities of a path would not be visible on even a single screen of the electronic display device 104, much less on a single line. In one embodiment, the tool 122 displays only a subset of the determined paths. Flow proceeds to block 316.

At block 316, the tool 122 analyzes each path according to one or more metrics to generate metric analysis information for each path. That is, for each path, the tool 122 applies metrics to the values of the attributes of the activities in the path to generate information that may be used by a project analyst to analyze the project. The manner in which the activities of the paths are analyzed at block 316 is similar to the manner in which the activities of the groups, or ribbons, are analyzed at block 216 as described above. Flow proceeds to block 318.

At block 318, the tool 122 displays the metric analysis information for each path that was generated at block 316. This is shown in FIG. 15 in the generic column titled “Ribbon Analyzer.” In the example of FIG. 15, the eight metrics from the Cost metric library have been applied to each of the paths and the metric analysis information for each of the eight metrics is displayed in eight columns to the right of the respective path. That is, each cell (intersection of a path row and Ribbon Analyzer metric column) displays metric analysis information for the metric (column) and path (row) intersection. The manner in which the metric analysis information of the paths is displayed at block 318 is similar to the manner in which the metric analysis information of the groups, or ribbons, is displayed at block 218 as described above. The display of the metric analysis information for project activities grouped according to path advantageously provides a very efficient and useful way for the project analyst to analyze the project, which is not provided by conventional project analysis tools. Flow proceeds to block 322.

At block 322, the tool 122 divides up each of the paths into time phases across the paths and identifies segments. Each segment is the intersection between a path and a time phase. A segment includes all the activities of the time phase-intersected path for which any of the duration of an activity falls within the intersecting time phase. Thus, as described above with respect to block 222, in block 322 the tool 122 may determine that an activity falls into multiple segments. Flow proceeds to block 324.

At block 324, the tool 122 analyzes each of the segments according to one or more metrics to generate metric analysis information for each of the segments identified at block 322. That is, the tool 122 applies metrics to the values of the attributes of the activities in the segment to generate information that may be used by a project analyst to analyze the project. The step performed at block 324 is similar to the step performed at block 316, except the set of activities analyzed at block 324 is the set of activities included in the relevant segment, rather than the set of activities included in the relevant path as at block 316. Activities that fall into multiple segments are processed in a manner similar to that described above with respect to block 224. Flow proceeds to block 326.

At block 326, the tool 122 displays the metric analysis information for each segment that was generated at block 324. The step performed at block 326 is similar to the step performed at block 226, except that the segments of block 326 are formed by the intersection of a path and a time phase, whereas the segments of block 226 are formed by the intersection of a group and a time phase. In the example of FIG. 15, twenty one segments are displayed (seven paths that intersect three time phases), including the corresponding metric analysis information for each of the segments. In the embodiment of FIG. 15, the user has selected the metric analysis information for the Cost Overrun metric to be displayed for each segment. In the example of FIG. 15, all twenty one of the segments are populated with activities; therefore, the tool 122 displays the metric analysis information for the Cost Overrun metric for all the segments. The display of the metric analysis information for project activities grouped according to path and then segmented by dividing the paths across time phases advantageously provides a very efficient and useful way for the project analyst to analyze the project, which is not provided by conventional project analysis tools. Flow ends at block 326.

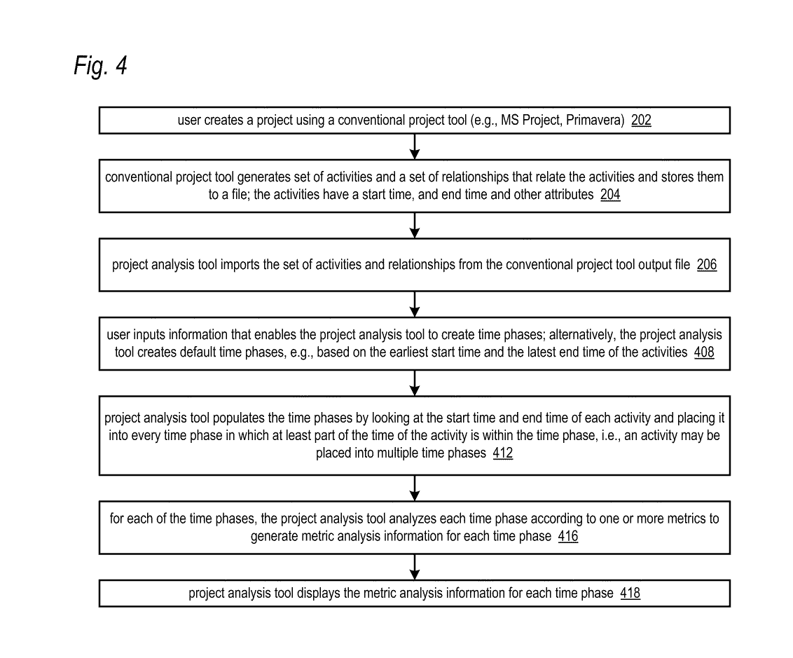

Referring now to FIG. 4, a flowchart illustrating operation of the project analysis tool 122 on the computer system 100 of FIG. 1 is shown. Flow begins at block 202. Blocks 202, 204, and 206 of FIG. 4 are similar to like-numbered blocks of FIG. 2. Flow proceeds from block 206 to block 408.

At block 408, the tool 122 creates time phases similar to the manner described above with respect to block 222, i.e., either based on time phase information received from the user or based on default time phase values. In one embodiment, the tool 122 computes a total project time based on the earliest start date of all the activities of the project and latest end date of all the activities of the project, rounds up to the nearest relevant time granularity (e.g., year), and then divides up the project time into a default number of time phases (e.g., three). As described above, the user may also divide existing time phases. Flow proceeds to block 412.

At block 412, the tool 122 populates the time phases by examining the start time and end time of each activity of the project and placing it into each time phase in which at least a part of the activity duration is within the time phase. Consequently, an activity may be placed into multiple time phases. The population of time phases with activities is different from the population of segments with activities. Specifically, a time phase is populated with all the activities of a project that fall into the time phase, irrespective of which group or phase, if any, an activity is grouped into. In contrast, an activity must fall into a time phase and be part of an intersecting group or phase in order to be included in a segment. Flow proceeds to block 416.

At block 416, the tool 122 analyzes each time phase according to one or more metrics to generate metric analysis information for each time phase. That is, for each time phase, the tool 122 applies metrics to the values of the attributes of the activities in the time phase to generate information that may be used by a project analyst to analyze the project. The step performed at block 416 is similar to the step performed at block 216, except the set of activities analyzed at block 416 is the set of activities included in a time phase, rather than the set of activities included in a group as at block 216. However, because an activity may fall into multiple time phases (unlike the case of a group at block 216 in which an activity may only fall into one group), when the tool 122 applies a metric to a time phase, if an activity falls within multiple time phases, the manner in which the tool 122 applies the attribute value for that activity varies depending upon the type of attribute. For some attribute types, the tool 122 pro-rates the attribute value among the different time phases according to the percentage of the activity's duration that lies within each of the different time phases. For example, if an activity has a total cost of $100,000 and 25% of its duration falls within the 2009 time phase and 75% of its duration falls with the 2010 time phase, then the tool 122 applies $25,000 to 2009 and $75,000 to 2010 for metric analysis purposes. For other attribute types, the tool 122 fully includes the attribute value in each of the different time phases. For still other attribute types, the tool 122 includes the attribute value only in the relevant time phase. Flow proceeds to block 418.

At block 418, the tool 122 displays the metric analysis information for each time phase that was created at block 408. This is shown in FIG. 15 in the generic row titled “Phase Analyzer.” In the example of FIG. 15, the eight metrics from the Cost metric library have been applied to each of the time phases and the metric analysis information for each of the eight metrics is displayed in eight rows below each of the respective time phases. That is, each cell (intersection of a Time Phase column and Phase Analyzer metric row) displays metric analysis information for the metric (row) and time phase (column) intersection. In other respects, the display of the metric analysis information is similar to the manner in which metric analysis information is displayed in the Ribbon Analyzer portion of the screen for groups, or ribbons, as described at block 218. In the example shown in FIG. 15, the tool 122 created three time phases which are the years 2009, 2010, and 2011. The display of the metric analysis information for project activities grouped according to time phase advantageously provides a very efficient and useful way for the project analyst to analyze the project, which is not provided by conventional project analysis tools. Flow ends at block 418.

As discussed above with respect to block 412, the tool 122 creates time phases, populates time phases, analyzes time phases, and displays metric analysis information of time phases, as described with respect to FIG. 4, independent of the creation of groups or paths as described above with respect to FIGS. 2 and 3. This is because the tool 122 simply looks at the start time and end time of each activity and places it into a time phase (or multiple time phases) whether or not an activity has been grouped by attribute or path.

Although embodiments have been described in which the activities of each group, or ribbon, are displayed along a horizontal line and time phases cut across the groups in a vertical fashion, embodiments are contemplated in which the activities of the group are displayed along a vertical line and the time phases cut across the groups in a horizontal fashion.

While various embodiments of the present invention have been described herein, it should be understood that they have been presented by way of example, and not limitation. It will be apparent to persons skilled in the relevant project management arts that various changes in form and detail can be made therein without departing from the scope of the invention. Thus, the present invention should not be limited by any of the exemplary embodiments described herein, but should be defined only in accordance with the following claims and their equivalents. Finally, those skilled in the art should appreciate that they can readily use the disclosed conception and specific embodiments as a basis for designing or modifying other structures for carrying out the same purposes of the present invention without departing from the scope of the invention as defined by the appended claims.

I claim:

1. A computer-implemented method, comprising:
using a computer to perform:
receiving a set of activities of a project, wherein each of the activities specifies a start time and attributes;
receiving, via an input device of the computer, user input that specifies an attribute from among the attributes of the set of activities;
grouping the activities into groups according to different values of the attribute; and
for each of the groups, displaying the activities of the group within a single horizontal line, wherein each of the activities is displayed in a location within the single horizontal line based on its start time, wherein said displaying comprises displaying the activities of the group on an electronic display device of the computer.

2. The computer-implemented method of claim 1, wherein said grouping the activities into groups according to different values of the attribute comprises:
grouping the activities into groups according to different discrete values of the attribute.

3. The computer-implemented method of claim 2, further comprising:
using the computer to perform:
dividing each of the groups into time phases across the groups;
identifying segments, wherein each of the segments comprises an intersection between one of the groups and one of the time phases;
analyzing each of the segments according to at least one metric to generate metric analysis information for each of the segments; and
displaying the metric analysis information for each of the segments.

4. The computer-implemented method of claim 1, wherein said grouping the activities into groups according to different values of the attribute comprises:
grouping the activities into groups according to different value ranges of the attribute.

5. The computer-implemented method of claim 4, further comprising:
using the computer to perform:
analyzing each of the groups according to at least one metric to generate metric analysis information for each of the groups; and
displaying the metric analysis information for each of the groups.

6. The computer-implemented method of claim 4, further comprising:
using the computer to perform:
dividing each of the groups into time phases across the groups;
identifying segments, wherein each of the segments comprises an intersection between one of the groups and one of the time phases;
analyzing each of the segments according to at least one metric to generate metric analysis information for each of the segments; and
displaying the metric analysis information for each of the segments.

7. The computer-implemented method of claim 6, wherein said displaying the metric analysis information for each of the segments comprises:
displaying the metric analysis information for each of the segments in visual association with the segment.

8. The computer-implemented method of claim 1, wherein each of the activities has a duration, wherein each of the activities of the group is displayed as a line whose length is proportional to its duration.

9. The computer-implemented method of claim 8, wherein said displaying the activities of the group within a single horizontal line comprises:
using visual shading to show overlap density of overlapping activities of a group and to show gaps between activities.

10. A computer-implemented method, comprising:
using a computer to perform:
receiving a set of activities of a project, wherein each of the activities specifies a start time;
receiving a set of relationships of the project, wherein each relationship specifies a preceding one of the activities and a succeeding one of the activities;
receiving, via an input device of the computer, user input that specifies a start entity and an end entity;
determining paths of the activities of the project between the start entity and the end entity using the set of relationships; and
for each of the paths, displaying the activities of the path within a single horizontal line, wherein each of the activities is displayed in a location within the single horizontal line based on its start time, wherein said displaying comprises displaying the activities of the path on an electronic display device of the computer.

11. The computer-implemented method of claim 10, wherein the start entity and the end entity comprise a start activity and an end activity, respectively, wherein the start activity and the end activity are from among the set of activities of the project.

12. The computer-implemented method of claim 10, wherein the start entity and the end entity comprise a start time and an end time, respectively.

13. The computer-implemented method of claim 10, wherein the start entity comprises a start activity and the end entity comprises and an end time.

14. The computer-implemented method of claim 10, wherein the start entity comprises a start time and the end entity comprises and an end activity.

15. The computer-implemented method of claim 10, further comprising:
using the computer to perform:
analyzing each of the paths according to at least one metric to generate metric analysis information for each of the paths; and
displaying the metric analysis information for each of the paths.

16. The computer-implemented method of claim 10, further comprising:
using the computer to perform:
dividing each of the paths into time phases across the paths;
identifying segments, wherein each of the segments comprises an intersection between one of the paths and one of the time phases;
analyzing each of the segments according to at least one metric to generate metric analysis information for each of the segments; and
displaying the metric analysis information for each of the segments.

17. A computer-implemented method, comprising:
using a computer to perform:
receiving a set of activities of a project, wherein each of the activities specifies a start time and end time;
creating a plurality of time phases;
populating the time phases with the activities based on the start time and the end time of each activity, wherein each of the activities may be placed into more than one of the time phases;
for each of the time phases, analyzing the time phase according to at least one metric to generate metric analysis information for each of the time phases; and
displaying the metric analysis information for each of the time phases, wherein said displaying comprises displaying the metric analysis information on an electronic display device of the computer.

18. A computer-readable memory medium comprising program instructions, wherein the program instructions are executable by a processor to implement:
receiving a set of activities of a project, wherein each of the activities specifies a start time and attributes;
receiving, via an input device of the computer, user input that specifies an attribute from among the attributes of the set of activities;
grouping the activities into groups according to different values of the attribute; and
for each of the groups, displaying the activities of the group within a single horizontal line, wherein each of the activities is displayed in a location within the single horizontal line based on its start time, wherein said displaying comprises displaying the activities of the group on an electronic display device of the computer.

19. The computer-readable memory medium of claim 18, wherein said grouping the activities into groups according to different values of the attribute comprises:
grouping the activities into groups according to different discrete values of the attribute.

20. The computer-readable memory medium of claim 19, wherein the program instructions are executable by the processor to further implement:
dividing each of the groups into time phases across the groups;
identifying segments, wherein each of the segments comprises an intersection between one of the groups and one of the time phases;
analyzing each of the segments according to at least one metric to generate metric analysis information for each of the segments; and
displaying the metric analysis information for each of the segments.

21. The computer-readable memory medium of claim 18, wherein said grouping the activities into groups according to different values of the attribute comprises:
grouping the activities into groups according to different value ranges of the attribute.

22. The computer-readable memory medium of claim 21, wherein the program instructions are executable by the processor to further implement:
analyzing each of the groups according to at least one metric to generate metric analysis information for each of the groups; and
displaying the metric analysis information for each of the groups.

23. The computer-readable memory medium of claim 21, wherein the program instructions are executable by the processor to further implement:
dividing each of the groups into time phases across the groups;
identifying segments, wherein each of the segments comprises an intersection between one of the groups and one of the time phases;
analyzing each of the segments according to at least one metric to generate metric analysis information for each of the segments; and
displaying the metric analysis information for each of the segments.

24. The computer-readable memory medium of claim 23, wherein said displaying the metric analysis information for each of the segments comprises:
displaying the metric analysis information for each of the segments in visual association with the segment.

25. The computer-readable memory medium of claim 18, wherein each of the activities has a duration, wherein each of the activities of the group is displayed as a line whose length is proportional to its duration.

26. The computer-readable memory medium of claim 25, wherein said displaying the activities of the group within a single horizontal line comprises:
using visual shading to show overlap density of overlapping activities of a group and to show gaps between activities.

27. A computer-readable memory medium comprising program instructions, wherein the program instructions are executable by a processor to implement:
receiving a set of activities of a project, wherein each of the activities specifies a start time;
receiving a set of relationships of the project, wherein each relationship specifies a preceding one of the activities and a succeeding one of the activities;
receiving, via an input device of the computer, user input that specifies a start entity and an end entity;
determining paths of the activities of the project between the start entity and the end entity using the set of relationships; and
for each of the paths, displaying the activities of the path within a single horizontal line, wherein each of the activities is displayed in a location within the single horizontal line based on its start time, wherein said displaying comprises displaying the activities of the path on an electronic display device of the computer.

28. The computer-readable memory medium of claim 27, wherein the start entity and the end entity comprise a start activity and an end activity, respectively, wherein the start activity and the end activity are from among the set of activities of the project.

29. The computer-readable memory medium of claim 27, wherein the start entity and the end entity comprise a start time and an end time, respectively.

30. The computer-readable memory medium of claim 27, wherein the start entity comprises a start activity and the end entity comprises and an end time.

31. The computer-readable memory medium of claim 27, wherein the start entity comprises a start time and the end entity comprises and an end activity.

32. The computer-readable memory medium of claim 27, wherein the program instructions are executable by the processor to further implement:
analyzing each of the paths according to at least one metric to generate metric analysis information for each of the paths; and
displaying the metric analysis information for each of the paths.

33. The computer-readable memory medium of claim 27, wherein the program instructions are executable by the processor to further implement:
dividing each of the paths into time phases across the paths;
identifying segments, wherein each of the segments comprises an intersection between one of the paths and one of the time phases;
analyzing each of the segments according to at least one metric to generate metric analysis information for each of the segments; and
displaying the metric analysis information for each of the segments.

34. A computer-readable memory medium comprising program instructions, wherein the program instructions are executable by a processor to implement:
receiving a set of activities of a project, wherein each of the activities specifies a start time and end time;
creating a plurality of time phases;
populating the time phases with the activities based on the start time and the end time of each activity, wherein each of the activities may be placed into more than one of the time phases;
for each of the time phases, analyzing the time phase according to at least one metric to generate metric analysis information for each of the time phases; and
displaying the metric analysis information for each of the time phases, wherein said displaying comprises displaying the metric analysis information on an electronic display device of the computer.
